(19) United States
(12) Patent Application Publication
(10) Pub. No.: US 2002/0161655 A1
(43) Pub. Date: Oct. 31, 2002

(54) METHODS AND APPARATUS FOR PROCESSING SMARTCARD TRANSACTIONS

(76) Inventor: JONATHAN L. BREDIN, HANOVER, NH (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/003,704

(22) Filed: Jan. 7, 1998

(51) Int. Cl. G06F 17/60

(52) U.S. Cl. 705/26

(57) ABSTRACT

A system for processing smartcard transactions stores contracts for the associated smartcard. The contracts specify rules under which a user may purchase services or products. When the user requests a particular product or service, the system obtains a contract for satisfying the request and activates the contract. Upon acceptance of the contract by the user, the system performs processing to obtain payment for and provide access to the requested service or product. A user may perform functions associated with the contracts. Contracts may be created, edited, deleted, or sold to other smartcard owners.

### FIELD OF THE INVENTION

The present invention relates to methods and apparatus for processing transactions involving smartcards.

### BACKGROUND OF THE INVENTION

Smartcards are credit card-type cards with a microprocessor that works in conjunction with a smartcard reader. The microprocessor processes transactions involving purchases of products or services. These transactions use a “purse” or stored data, in the card, identifying the value of the card. A smartcard typically includes data encryption capabilities for secure transactions. In general, when a user inserts a smartcard into a reader, a user-interface or screen typically displays to the user a value present in the smartcard and it allows the user to conduct the transaction involving the smartcard. A user may, for example, use the smartcard to purchase a particular product, at which time the smartcard reader will verify the transaction and reduce the purse by a corresponding amount.

Smartcards have the advantage of increased security in comparison to well-known credit cards. With a credit card transaction, a credit card number is typically sufficient to perform the transaction, especially with telephone transactions. With a smartcard, however, the actual card is required to perform a transaction. Therefore, there is no number that may be separately used for a transaction.

Because of their processing capabilities, smartcards may also gather information about a user such as medical history and store the information in the storage of the card. The user may then have an easy and convenient means to transport the information, for example, to a doctor's office without requiring an equivalent amount of paper records. In addition, the information stored within a smartcard is more secure in that only authorized persons may access the data. Smartcards may similarly store other information relating to the user.

Smartcards also allow financial institutions or other entities to track purchases of smartcard users. Since a smartcard typically allows a user more flexibility in making purchases, particularly purchases of a small amount, it provides an improved means to track a user's purchases and gather related marketing information. For example, information on a user's purchase of a particular product with a smartcard may be saved through a network and sold to sellers of competing products. These competitors may then use that information in order to market their products toward that particular user.

The functionality present within the microprocessor in a smartcard, however, has not been fully utilized for the advantage of the smartcard holder. Accordingly, a need exists for increased functionality for smartcard users.

### SUMMARY OF THE INVENTION

An apparatus consistent with the present invention includes a receive component configured to receive a request for a particular service or product from a user of a smartcard. It includes a component configured to specify a contract, associated with the smartcard, identifying terms under which the user is permitted to access the service or product. It also includes a component configured to activate the contract in response to the request to provide the user with access to the service or product.

Another apparatus consistent with the present invention includes a component configured to specify a plurality of contracts, associated with a particular smartcard, identifying terms under which the user is permitted to access a plurality of services or products. It also includes a receive component configured to receive a request to view the plurality of contracts and a component configured to display the plurality of contracts.

A method consistent with the present invention includes the following steps: receiving a request for a particular service or product from a user of a smartcard, specifying a contract, associated with the smartcard and identifying terms under which the user is permitted to access the service or product, activating the contract in response to the request to provide the user with access to the service or product.

### BRIEF DESCRIPTION OF THE DRAWINGS

The accompanying drawings are incorporated in and constitute a part of this specification and, together with the description, explain the advantages and principles of the invention. In the drawings,

FIG. 1 is a block diagram of components of a system for processing smartcard transactions consistent with the present invention;

FIG. 2 is a block diagram of a smartcard;

FIG. 3 is a block diagram of modules of a program for processing smartcard transactions consistent with the present invention;

FIGS. 4A and 4B are a flow chart of steps for processing smartcard transactions consistent with the present invention;

FIG. 5 is a flow chart of steps for verifying a smartcard transaction;

FIG. 6 is an example of a user interface related to smartcard transactions; and

FIG. 7 is an example of a user interface for displaying and permitting user to select contracts associated with a particular smartcard.

### DETAILED DESCRIPTION

The following detailed description of the invention refers to the accompanying drawings. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

### Introduction

Methods and apparatus consistent with the present invention use the functionality available with a microprocessor in a smartcard for increasing the versatility of smartcards. In particular, a program associated with a particular smartcard stores one or more contracts specifying terms or conditions under which an owner or other user of the smartcard can access products or services. When the smartcard owner or user requests a particular service or product, the program activates a corresponding contract for permitting, under the terms of the contract, access to the requested service or product. The program typically permits the owner or user to accept or decline the contract under which they may access the requested service or product.

The owner or user of a smartcard may typically view a contract inventory for the smartcard and edit the viewed contracts. They may also typically create contracts, add the contracts to the inventory, and issue stored contracts to other smartcard owners.

### System Configuration

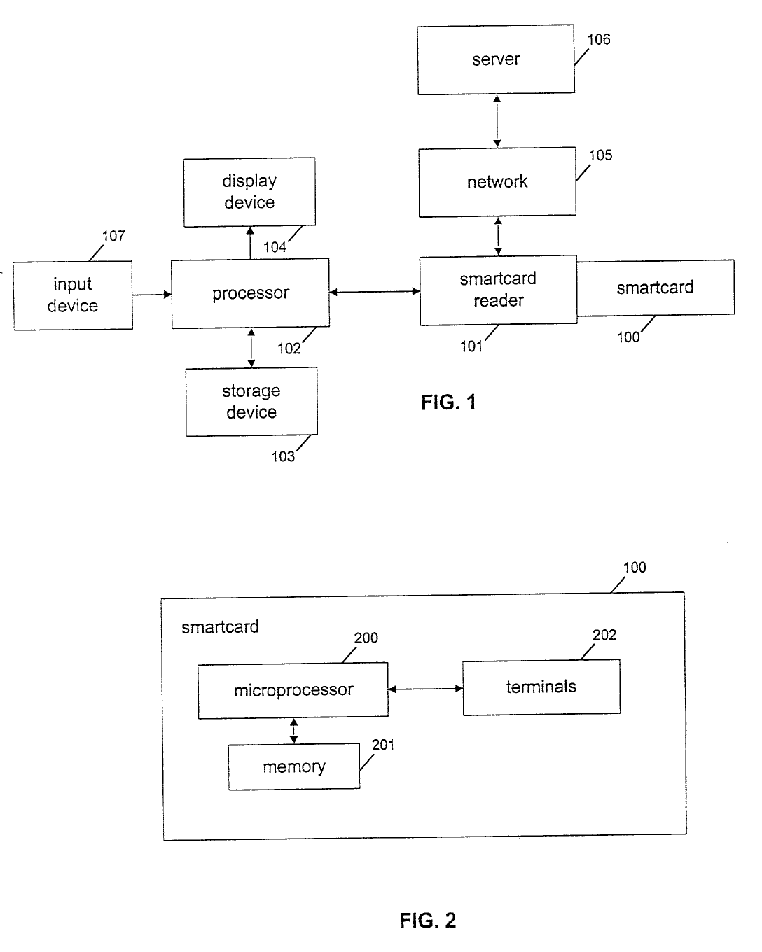

FIG. 1 illustrates components of a system for processing smartcard transactions consistent with the present invention. A device, such as a smartcard reader 101, transfers information to and from the smartcard 100. Smartcard readers are commercially available and include such examples as the ASEDrive smartcard reader sold by Aladdin Knowledge Systems Ltd. and the SmartWriter smartcard reader sold by Artech Datatronic Systems. The information from the smartcard is preferably transferred to a processor 102 for operating under software control to perform various functions relating to smartcard transactions. Processor 102 is interfaced to a display device 104 for displaying information concerning the smartcard and for receiving commands from the user. Display device 104 may be implemented with any type of display, such as a CRT display or an LCD screen. Processor 102 is also connected to an input device 107, such as a keyboard or cursor-control device, for entering information into processor 102.

Alternatively, a server 106 may receive smartcard information through a network 105 and communicate with smartcard reader 101 through network 105. Server 106 may be connected to another processor and associated input and display devices for allowing a user to enter and receive information through server 106. Accordingly, a processor or other server need not be directly linked to a smartcard reader and correspondingly need not be located physically close to the smartcard reader or smartcard user.

Processor 102 or server 106 operates under the control of a program for processing smartcard transactions. An exemplary embodiment of such a program is referred to as a “marketeer program.” The term “marketeer” is intended as only a label to identify an exemplary program. It is not intended to limit such programs to marketing or marketing-related activities. The marketeer program may be stored in storage device 103 or server 106, which includes a computer-readable medium such as hard disk drive, or, alternatively, may be stored within the smartcard itself. In addition, a marketeer program may be embodied in a computer data signal in a carrier wave. The computer data signal represents sequences of instructions which, when executed by a processor, cause it to address a peripheral device at an absolute address by performing steps of the marketeer program.

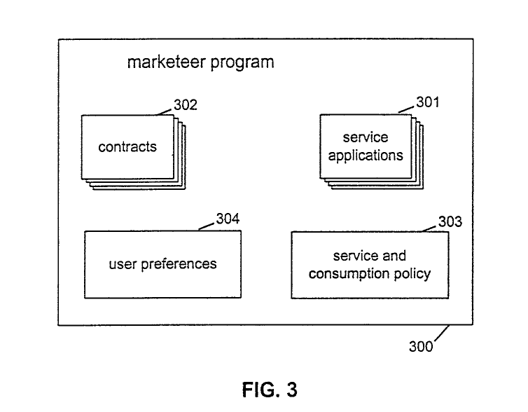

FIG. 2 is a diagram of typical components of smartcard 100. It includes a microprocessor 200 interfaced with a memory 201 including a computer readable medium. Microprocessor 200 is connected to terminals 202 for transmitting information to, and receiving information from, a smartcard reader. Terminals 202 may be one or more metal electrical contacts on the card, or optical connector(s). Alternatively, terminals 202 may use electromagnetic energy to transmit a signal through the card, which provides the advantage of permitting reading of the card without requiring that it be removed from, for example, a user's wallet. The components (201-202) are typically encased within a thin plastic card.

### Marketeer Program

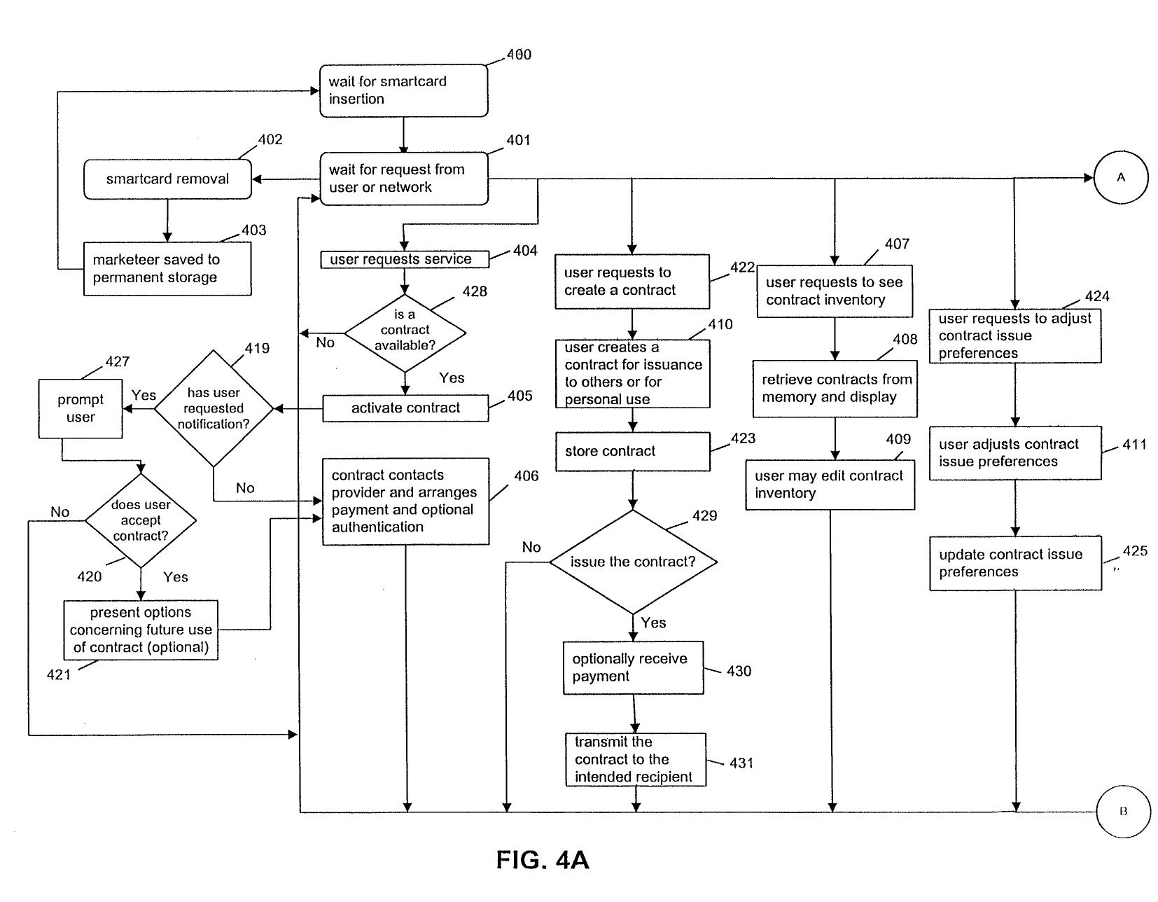

FIG. 3 is a diagram of modules for a marketeer program 300. Marketeer program 300 includes service applications 301 which may include various programs for conducting smartcard transactions. They may include personal programs, examples of which are provided below.

Contracts 302 include terms under which a user is permitted to purchase a product or a service from a provider. Contracts 302 thus are sets of rules controlling purchases. These contracts may include pricing schedules, and service or product availability in the event that a provider is temporarily unavailable. Contracts 302 are typically stored as a series of rules for each particular contract.

Service and consumption policy 303 contains rules governing sales of services, products, or stored contracts to other users or marketeer programs. Thus, while marketeer program 300 uses contracts for purchases, it uses in comparison service and consumption policy for sales. Service and consumption policy 303 may be stored as sets of rules governing sales. For example, particular persons may be given preference in sales of contracts.

A list of user preferences 304 include information identifying personal preferences of a user in terms of products or services that the user may purchase or desire. This information may be entered or altered by a user, and it may be used to govern, for example, terms under which a marketeer program will sell a particular contract to another user.

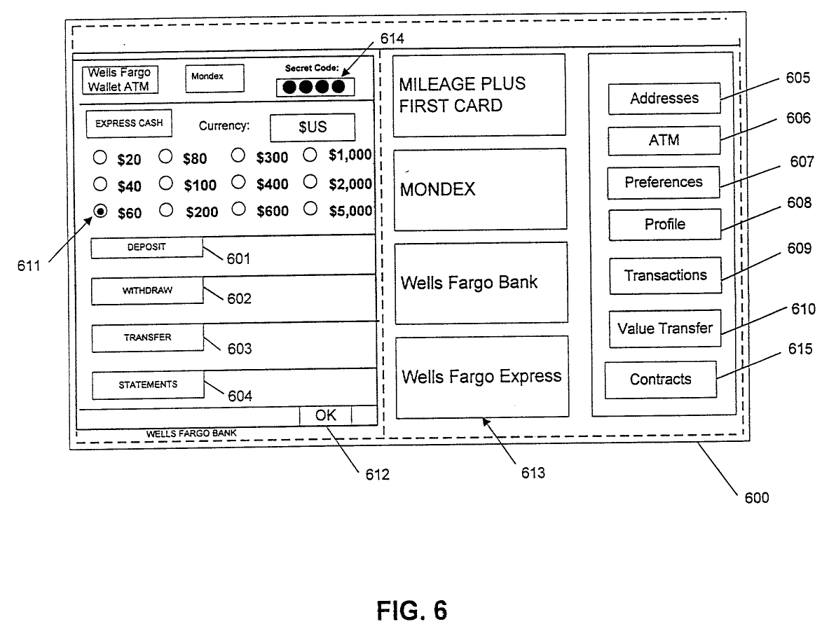

Marketeer program 300 also typically stores other information, such as the information displayed in the user interface shown in FIG. 6.

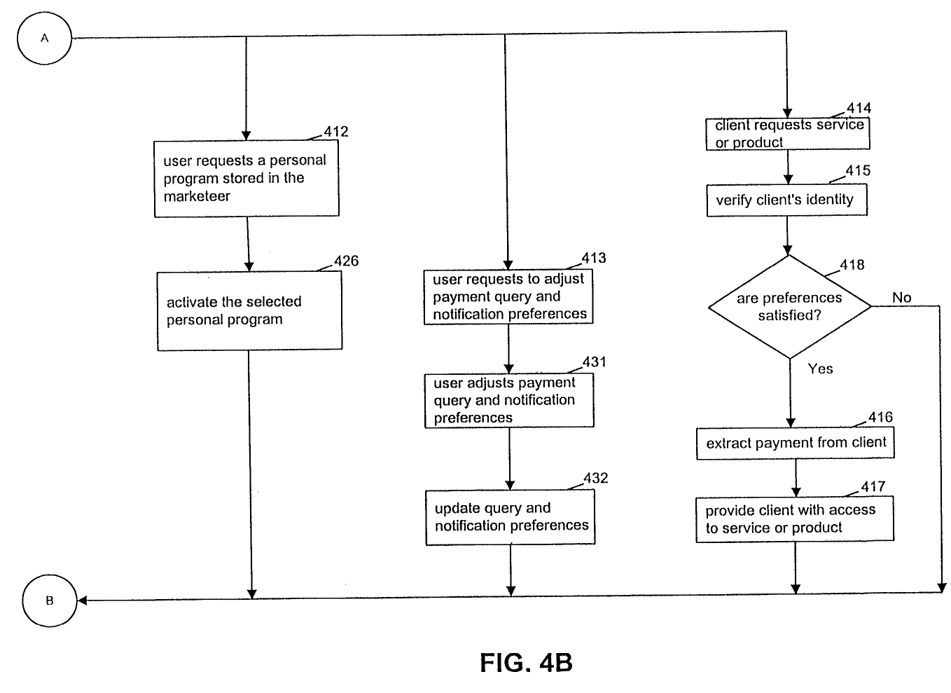

FIGS. 4A and 4B are a flow chart of various processes of marketeer program 300 consistent with the present invention. Marketeer program 300, through processor 102 or server 106, may take several actions, such as requesting a contract from another marketeer program, displaying a contract or catalog of contracts to the user, prompting a user to accept a contract and allowing the user to dismiss future prompts, activating a contract, creating a contract, issuing a contract, and deleting a contract from memory.

During typical processing of a marketeer program, the system waits for a smartcard to be inserted into a reader or to otherwise receive smartcard information through the network or from the smartcard (step 400), and waits for a request from a user or network, at which time it opens and activates a marketeer program corresponding to the smartcard (step 401). Alternatively, processing may begin with the system waiting for a request (step 401). When a smartcard is removed from the reader or the smartcard processing is otherwise complete (step 402), the system saves the corresponding marketeer program to permanent storage (step 403), accessible to the server or other processor. Alternatively, upon receiving an indication that a user has completed the transactions, and before removal of the smartcard from a reader, the system may store the marketeer program on the smartcard itself.

Upon activation of a smartcard marketeer program, a system may perform various functions. If a marketeer's owner requests service (step 404), it determines if a contract is available in contract inventory 302 (see FIG. 3) to satisfy the request (step 428). If no contract is available, then the system is typically unable to provide access to the service or product, unless a contract is created at the time of the transaction, because there are no rules or terms governing a response to such request. Otherwise, the system activates or invokes a contract that it has located in the contract inventory 302 for providing access to the requested service or product (step 405).

A user may request service in a number of ways, such as entering a request to purchase a particular product or service. In response, the system determines if a contract is available within a corresponding marketeer program governing terms under which the system may satisfy the request. This contract may include any number of terms under which a user may purchase services or products, and examples are provided below.

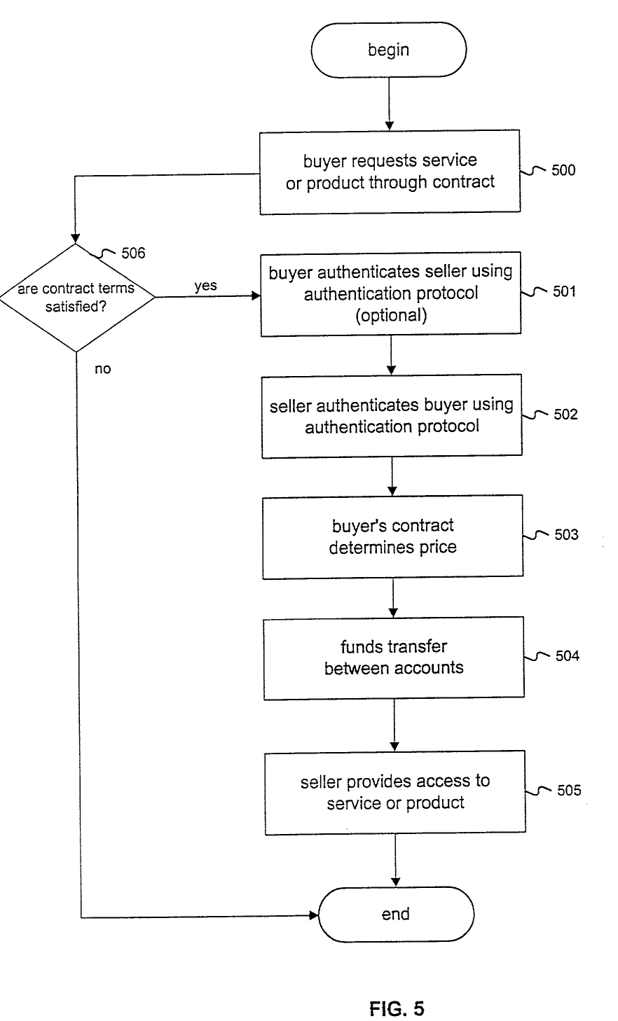

After typically activating a particular contract corresponding to the request, the system optionally determines if the user has requested notification (step 419). In some cases a user may repeatedly use a contract and thus not desire repeated notification. If the user does not desire notification, the system attempts to provide access to the requested product or service (step 406), which is explained in more detail in FIG. 5.

Otherwise, the system prompts the user (step 427), which may include displaying an identification of the contract to the user. It determines whether the user accepts the contract (step 420). If the user accepts, the system optionally presents options to the user concerning future use of the contract (step 421). These options include, for example, whether the user wants to dismiss future prompts and not receive notification as provided in step 419, or to suppress further notification until the available cash balance decreases to a certain value, the price of the requested service or product increases beyond a certain threshold, or the service or product request frequency increases above a certain level. The system may use the last option to provide greater security for a particular entity providing a service. The system then attempts to provide access to the requested product or service (step 406).

The following are examples of contracts that may exist within contract inventory 302. These are intended as only examples of contracts for illustrating an embodiment consistent with the present invention. A first exemplary contract checks to see how many users are currently using a particular product. It either limits the number of concurrent users or makes the price a function of the number of active users (e.g. high use results in a higher price). A second exemplary contract files a log report to a central authority to track usage of a service by anyone or the user's own particular usage of the service. A third exemplary contract checks to see how often the user has used a particular service. It may use this information to calculate price, limit access, or sell information to marketers. A fourth exemplary contract restricts options for a particular service; for example, it may either log or limit access to a network domain known to have non work-related resources.

A user may create a contract and issue it to others to be stored within marketeer programs corresponding to their smartcards. A user requests to create a contract (step 410). A user may enter this request, for example, using input device 107 (see FIG. 1). The user then enters or otherwise creates a contract (step 410), which may be created for the user's own use or to issue to others. In order to enter or create a contract, a user typically uses input device 107 (see FIG. 1) for entering the rules for such a contract. The system typically stores it within contract inventory 302 (step 423). That contract is then available for use or issuance to another marketeer program.

A user may enter a request to transfer that contract, or another identified contract (step 429). In response, the system transfers the contract (step 431), which typically involves sending the contract by using a network address for the receiving marketeer program, which receives and stores the transmitted contract, making it available to the user of the corresponding smartcard. Issuing a contract optionally involves receiving payment for it (step 430).

A system may display a contract inventory to the user. A user enters a request to view a contract inventory of their smartcard (step 407). The system retrieves the contracts from contract inventory 302 (see FIG. 3) for the corresponding marketeer program and displays them (step 408). A user may alternatively edit the contract inventory while it is displayed (step 409). Such editing may involve deleting a displayed contract or altering rules for a displayed contract. The user may perform this editing using, for example, input device 107 (see FIG. 1).

A user may also adjust contract issue preferences, explained above, by entering a request to do so (step 424). The user adjusts issue preferences for a selected contract (step 411), and the system stores the updates (step 425). The user may enter the updates using, for example, input device 107 (see FIG. 1).

A user may request to activate a personal program stored in marketeer program associated with their smartcard (step 412). In response, the system activates the selected personal program (step 426). These programs may include any number of user applications associated with money transfer, purchases, organizational tools, or even games. Examples include a card transaction log program, a movie or travel agent ticketing program capable of contacting vendors and obtaining an optimum price, a date/address book, an automatic teller machine (ATM) funds transfer application, or static data such as pictures or text. The use of personal programs makes use of the processing capabilities of a microprocessor within a smartcard. It permits a smartcard owner to use a smartcard to perform any number of functions in assisting their purchase of goods or services. For example, a smartcard may contain the program for searching a network to obtain the best price for a particular product or service, or obtain an optimum price within a certain geographic region.

A user may request to adjust payment query and notification preferences (step 413). These preferences typically control notification such as is described with respect to steps 419 and 421 and may include how payment for services or products is accomplished. A user adjusts payment query and notification preferences (step 41), and the system stores the updated information (step 432).

In addition, a marketeer program may sell services or products to a client. It receives a request from a client for a particular product or service (step 414). The system verifies the client's identity (step 415). The system obtains payment from the client (step 416), which may involve adjusting the purses of the buying and selling smartcards in order to decrease the purse of the buying smartcard and increase by a corresponding amount the purse of the selling smartcard. If payment is successfully accomplished, the system provides access to the requested service or product (step 417).

FIG. 5 is a flow chart of processing for a transaction protocol to implement step 406 shown in FIGS. 4A and 4B. As shown in FIG. 5, a buyer (smartcard user) requests a service through a contract typically within the smartcard (step 500). The system determines if the contract terms are satisfied (step 506) and, if so, attempts to provide access to the requested service or product. The buyer optionally authenticates the seller using authentication protocol (step 501). An example of an authentication protocol is Mondex authentication by Mondex International Limited. Other protocols are possible for authenticating transactions.

The seller authenticates the buyer using authentication protocol (step 502). A buyer's contract determines the price for the transaction (step 503). The funds required for the contract are transferred between accounts (step 504), which typically involves adjusting the purse in the smartcard in order to extract payment. Following the transfer of funds for the contract, a seller provides access to the service or product (step 505).

### User Interfaces for a Marketeer Program

FIG. 6 is an example of a user interface for a user to enter commands into the system and view information concerning their smartcard. In a display 600 a user may view an indication of a dollar amount for adjusting the purse of their card in window 611. Display 600 is typically presented on display device 104 (see FIG. 1) or, if the processing occurs through a server, it may be presented on a display device connected to the server. The user may perform these functions by manipulating the appropriate key, such as requesting a deposit (601), a withdrawal (602), a transfer of funds (603), or statements concerning transactions (604). The user may confirm the requested transaction by selected OK icon 612, and window 614 may be used to indicate entry of a code for use in authenticating transactions or verifying a smartcard user.

Display 600 may include various icons for permitting a user to access programs or information. A user may use icon 605 for accessing an address book. Icon 606 may be used to access an ATM funds transfer program. Icon 607 may be used to access preferences 304 (see FIG. 3) stored within the marketeer program. Icon 608 may be used to access a smartcard user's particular profile. Icon 609 may be used to access transactions such as a deposit, withdrawal, or transfer of funds. Icon 610 may be used to access a value transfer function. Icons in window 613 may display various types of smartcards that may be read. Icon 615 may be used to view contract inventory 302 (see FIG. 3).

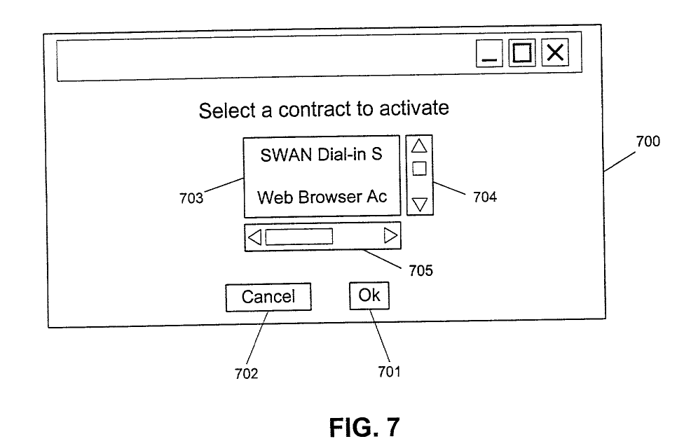

FIG. 7 is an example of a display 700 for displaying contracts to a smartcard user and for allowing them to select a particular contract. Display 700 is typically presented on display device 104 (see FIG. 1) or, if the processing occurs through a server, it may be presented on a display device connected to the server. Display 700 may include a window 703 for displaying to the user the plurality of contracts stored within their marketeer program. A user may view the inventory by manipulating scroll bars 704 and 705, and the user may select a particular program by, for example, highlighting it. And by manipulating OK icon 701 and cancel icon 702, a user may select a particular contract for execution by the marketeer program or cancel their selection.

While the present invention has been described in connection with a preferred embodiment thereof, it will be understood that many modifications will be readily apparent to those skilled in the art, and this application is intended to cover any adaptations or variations thereof. For example, various rules and terms may be used in contracts without departing from the scope of the invention. It is manifestly intended that this invention be limited only by the claims and equivalents thereof.

What is claimed is:

1. An apparatus for processing smartcard transactions, comprising:
a receiving component configured to receive a request for a particular service or product from a user of a smartcard;
a component configured to specify a contract, associated with the smartcard, identifying terms under which the user is permitted to access the service or product; and
a component configured to activate the contract in response to the request to provide the user with access to the service or product.

2. The apparatus of claim 1 wherein the receiving component comprises a component configured to receive the request from a smartcard reader or from a network connection.

3. The apparatus of claim 1, further comprising a component configured to permit the user to accept the contract.

4. An apparatus for processing smartcard transactions, comprising:
a component configured to specify a plurality of contracts, associated with a particular smartcard, identifying terms under which the user is permitted to access a plurality of services or products;
a receiving component configured to receive a request to view the plurality of contracts; and
a component configured to display the plurality of contracts.

5. The apparatus of claim 4, further comprising a component configured to permit the user to edit a selected one of the contracts.

6. The apparatus of claim 4, further comprising a component configured to permit the user to issue a selected one of the contracts to another smartcard user.

7. The apparatus of claim 6, further comprising a component configured to specify contract issue preferences identifying terms under which the apparatus is permitted to issue the contract.

8. The apparatus of claim 4, further comprising a component configured to permit the user to adjust payment query and notification preferences relating to the contracts.

9. The apparatus of claim 4, further comprising a component configured to sell services or products to a user of another smartcard.

10. A system for processing smartcard transactions, comprising:
an input/output device for reading information from and writing information to a smartcard;
a storage device for specifying a contract, associated with the smartcard, identifying terms under which the user is permitted to access a particular service or product; and
a processing device coupled to the receive device and the storage device, the processing device comprising:
a receiving component configured to receive a request for the particular service or product from the user of the smartcard; and
a component configured to activate the contract in response to the request to provide the user with access to the service or product.

11. The system of claim 10 wherein the receiving component comprises a component configured to receive the request from a smartcard reader or from a network connection.

12. The system of claim 10, further comprising a component configured to permit the user to accept the contract.

13. A method of processing smartcard transactions, comprising the steps of:
receiving a request for a particular service or product from a user of a smartcard;
specifying a contract, associated with the smartcard, identifying terms under which the user is permitted to access the service or product; and
activating the contract in response to the request to provide the user with access to the service or product.

14. The method of claim 13 wherein the receiving step includes the step of receiving the request from a smartcard reader or from a network connection.

15. The method of claim 13, further comprising the step of permitting the user to accept the contract.

16. A data structure stored in a computer readable medium for use by a processor in processing smartcard transactions, comprising:
an identification of an owner of a smartcard;
a plurality of contracts, each of the contracts specifying terms under which the owner is permitted to access corresponding services or products; and
an identification of an adjustable currency value for use in obtaining access to the services or products.

17. The data structure of claim 16, further comprising:
information identifying service and consumption policy for sales of the contracts;
a computer-executable application program associated with the smartcard; and
information identifying the user's personal preferences related to services or products.

18. A computer program product, comprising:
a computer usable medium having computer readable code embodied therein for use in transmitting objects in a distributed system comprised of multiple machines, comprising:
a receiving module configured to receive a request for a particular service or product from a user of a smartcard;
a module configured to specify a contract, associated with the smartcard, identifying terms under which the user is permitted to access the service or product; and
a module configured to activate the contract in response to the request to provide the user with access to the service or product.

19. The computer program product of claim 18 wherein the receiving module comprises a module configured to receive the request from a smartcard reader or from a network connection.

20. The computer program product of claim 18, further comprising a module configured to permit the user to accept the contract.

21. A computer data signal embodied in a carrier wave and representing sequences of instructions which, when executed by a processor, cause the processor to securely address a peripheral device at an absolute address by performing the steps of:
receiving a request for a particular service or product from a user of a smartcard;
specifying a contract, associated with the smartcard, identifying terms under which the user is permitted to access the service or product; and
activating the contract in response to the request to provide the user with access to the service or product.

22. The computer data signal of claim 21 wherein the receiving step includes the step of receiving the request from a smartcard reader or from a network connection.

23. The computer data signal of claim 21, further comprising the step of permitting the user to accept the contract.
